(19) United States
(12) Patent Application Publication
(10) Pub. No.: US 2024/0175997 A1
(43) Pub. Date: May 30, 2024

(54) TIME-OF-FLIGHT DEMODULATION CIRCUITRY, TIME-OF-FLIGHT DEMODULATION PORTION, AND TIME-OF-FLIGHT DEMODULATION METHOD

(71) Applicant: Sony Semiconductor Solutions Corporation, Atsugi-shi, Kanagawa (JP)

(72) Inventors: Ferhat TASDEMIR, Stuttgart (DE); Qing DING, Stuttgart (DE)

(73) Assignee: Sony Semiconductor Solutions Corporation, Atsugi-shi, Kanagawa (JP)

(21) Appl. No.: 18/282,541

(22) PCT Filed: Mar. 10, 2022
(86) PCT No.: PCT/EP2022/056164

§ 371 Date: Sep. 18, 2023

(30) Foreign Application Priority Data
Mar. 25, 2021 (EP) 21165017.1

(51) Int. Cl. G01S 7/4913; G01S 7/481; G01S 7/4865; G01S 7/497

(52) U.S. Cl. CPC G01S 7/4913; G01S 7/4816; G01S 7/4865; G01S 7/497

(57) ABSTRACT

The present disclosure generally pertains to time-of-flight demodulation circuitry, configured to: apply, for a predetermined time period, a first modulation signal to a first signal path including a first light detection element; apply, for the predetermined time period, a second modulation signal to a second signal path including a second light detection element; and after the predetermined time period, transfer the first modulation signal from the first signal path to the second signal path and transfer the second modulation signal from the second signal path to the first signal path.

### TECHNICAL FIELD

The present disclosure generally pertains to time-of-flight demodulation circuitry, a time-of-flight demodulation portion, and a time-of-flight demodulation method.

### TECHNICAL BACKGROUND

Generally, depth measurement devices and methods are known. For example, time-of-flight (ToF) devices/cameras measure a distance or depth from a scene based on a roundtrip delay of emitted light.

The roundtrip delay may be measured directly by measuring the time of the roundtrip, in which case such methods may be called direct ToF (dToF), or may be measured indirectly by measuring a phase-shift of reflected and then detected light, in which case such methods may be referred to as indirect ToF (iToF).

In iToF, a modulated light source may be used, wherein a modulation signal (for modulating the light source) may be delayed and “reused” (applied to a pixel of an iToF sensor, for example) in order to determine the phase-shift.

In some instances, four (but at least two) of such delayed applications of the modulation signal are needed to determine the depth.

Although there exist techniques for carrying out an iToF measurement, it is generally desirable to provide time-of-flight demodulation circuitry, a time-of-flight demodulation portion, and a time-of-flight demodulation method.

### SUMMARY

According to a first aspect the disclosure provides time-of-flight demodulation circuitry, configured to:
apply, for a predetermined time period, a first modulation signal to a first signal path including a first light detection element;
apply, for the predetermined time period, a second modulation signal to a second signal path including a second light detection element; and
after the predetermined time period, transfer the first modulation signal from the first signal path to the second signal path and transfer the second modulation signal from the second signal path to the first signal path.

According to a second aspect, the disclosure provides a time-of-flight demodulation portion comprising:
a substrate;
a first and a second light detection element;
an amplifier; and
time-of-flight demodulation circuitry, configured to:
apply, for a predetermined time period, a first modulation signal to a first signal path including the first light detection element;
apply, for the predetermined time period, a second modulation signal to a second signal path including the second light detection element; and
after the predetermined time period, transfer the first modulation signal from the first signal path to the second signal path and transfer the second modulation signal from the second signal path to the first signal path.

According to a third aspect, the disclosure provides a time-of-flight demodulation method, comprising
applying, for a predetermined time period, a first modulation signal to a first signal path including a first light detection element;
applying, for the predetermined time period, a second modulation signal to a second signal path including a second light detection element; and
after the predetermined time period, transferring the first modulation signal from the first signal path to the second signal path and transferring the second modulation signal from the second signal path to the first signal path.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a schematic diagram of a ToF demodulation portion according to the present disclosure;

FIG. 2 depicts ToF demodulation circuitry according to the present disclosure;

FIG. 3 depicts a timing diagram example of signals applied to the ToF demodulation circuitry of FIG. 2;

FIG. 4 depicts an extended version of the timing diagram of FIG. 3 and a charge flow direction in the ToF demodulation circuitry of FIG. 2;

FIG. 5 depicts a comparison of voltage progressions of ToF demodulation circuitry without chopping and with chopping with an example of two-times chopping;

FIG. 6 depicts further embodiments of ToF demodulation circuitries with different readout/integration circuitries;

FIG. 7 depicts a ToF demodulation method according to the present disclosure;

FIG. 8 illustrates a ToF imaging apparatus according to the present disclosure;

FIG. 9 depicts ToF readout circuitry according to the present disclosure as a clamp stage; and

FIG. 10 depicts a timing diagram for two nodes of the readout circuitry of FIG. 9;

FIG. 11 depicts ToF readout circuitry (top) according to the present disclosure wherein, photodiodes are read based on an embodiment predetermined timings (bottom); and

FIG. 12 depicts ToF readout circuitry (top) according to the present disclosure, wherein photodiodes are read based on another embodiment of predetermined timing (bottom).

### DETAILED DESCRIPTION OF EMBODIMENTS

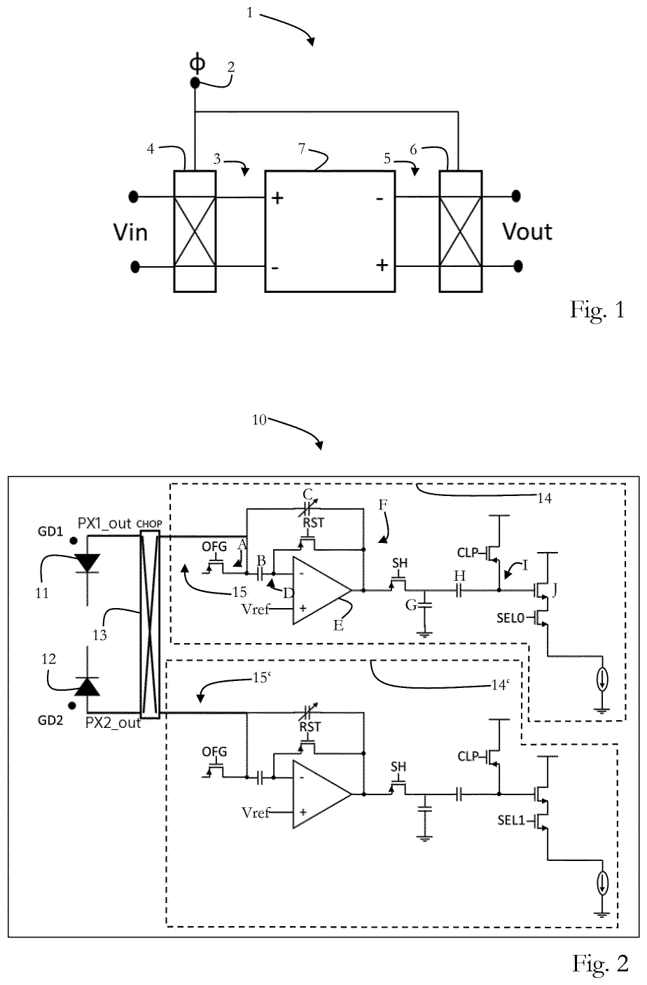

Before a detailed description of the embodiments starting with FIG. 1 is given, general explanations are made.

As mentioned in the outset, iToF is generally known. For two-tap iToF, in which a modulation signal is applied to two different readout nodes, a tap mismatch may occur with respect to gain and/or offset. Tap mismatches may impact signals accumulated in each readout-phase (or cycle) and thereby falsify a depth measurement and decrease/limit a sensor's depth accuracy.

Known methods may decrease a tap mismatch by decreasing a frame rate and/or using more than four phase measurements (also known as quads). However, in some instances, this would result in an increase of measurement time.

Other known methods implement a different pixel reset structure. However, it may be desirable to bias a pixel with a negative bias, which may not be possible in known methods.

Hence, it has been recognized that it is desirable to decrease or remove tap mismatches and to reduce a pixel noise in iToF pixels while increasing a frame rate.

It has further been recognized that it is desirable to provide a readout circuit for short-wave infrared with low (reset) noise, and to provide a light detector with a wide-range detector bias. Moreover, according to the present disclosure, a conversion gain may be adapted at an integration capacitor and a reset level of a source follower input may be programmed independently.

Therefore, some embodiments pertain to time-of-flight demodulation circuitry, configured to: apply, for a predetermined time period, a first modulation signal to a first signal path including a first light detection element; apply, for the predetermined time period, a second modulation signal to a second signal path including a second light detection element; and after the predetermined time period, transfer the first modulation signal from the first signal path to the second signal path and transfer the second modulation signal from the second signal path to the first signal path.

Demodulation circuitry may pertain to any entity or multitude of entities adapted to apply or control signals for light detection elements, such as a CPU (central processing unit), GPU (graphics processing unit), FPGA (field-programmable gate array), integrated circuits, e.g. mixer, demodulator or combinations thereof, such that an electric signal generated in the light detection elements in response to a detection of modulated light can be demodulated.

Light detection element may refer to any type of element or circuitry in which an electric signal is generated in response to light being incident on the light detection element, such as a photodiode, a CAPD (current-assisted photonic demodulator), or the like.

The light detection elements (and/or the demodulation circuitry according to the present disclosure) may be implemented based on known techniques, e.g. in a semiconductor, such as CMOS (comple-mentary metal oxide semiconductor), CCD (charge-coupled device), InGaAs or the like. However, the present disclosure is not limited to any specific type of semiconductor type or material. Hence, the present disclosure may be implemented based on a silicon-based semiconductor and/or based on a III-V material semiconductor, as will be discussed further below. It may also be envisaged to have a layered or stacked semiconductor structure, in which one layer may be based on silicon and another layer may be based on a III-V material or other materials, such as organic photodiodes, Ger-manium based photodiodes, or the like.

Generally, according to the present disclosure, short-wavelength infrared measurements (SWIR) may be carried out, but the present disclosure is not limited to SWIR measurement as any wavelength range may be envisaged.

The light detection elements may generate an electric signal, as discussed above, and the electric signal may be integrated by passive or active integrator or amplified by amplifying circuits. For example, if a stacked or hybrid image sensor (including the light detection elements) is used, a capacitive transimpedance amplifier (CTIA) may be used to integrate and store the generated signals.

A first modulation signal may be applied to a first light detection element for a predetermined time period and a second modulation signal may be applied to a second light detection element for the predetermined time period. The first light detection element may be included in a first signal path and the second light detection element may be included in a second signal path.

The first and the second signal paths may be parallel signal paths and may be each provided with corresponding readout circuitry (which will be discussed further below).

The first and the second modulation signals may be the same signal, i.e. may derive from a common signal source (e.g. the same signal may be split onto the two signal paths), or may be different signals.

The first light detection element may be of a same type (e.g. photodiode) or of different types.

However, the first and second modulation signals may correspond to each other with respect to a signal shape. For example, both the first and the second modulation signals may be based on a rec-tangular signal shape and a signal frequency may be (roughly) the same, since the first and the second modulation signals may be based on a time-delay of a modulation signal for a light source, as it is generally known in the field of time-of-flight.

On the other hand, at least the phase of the first and the second modulation signals may be different. For example, the first modulation signal may have a (relative) phase of zero degrees and the second demodulation signal may have one of a phase of ninety degrees, one-hundred-eighty degrees, or two-hundred-seventy degrees. It should be noted that exemplarily, the case of a four-phase measurement is described herein, but the present disclosure is not limited to any predetermined phase-shift (and number of phase measurements). For example, eight phases may be determined, wherein a respective phase-shift between the single measurements is forty-five degrees. Also, in a four-phase measurement, the phase-shifts are not limited to a phase-shift of ninety degrees and the phases may be adjusted accordingly by the person skilled in the art.

As it is generally known in the field of time-of-flight, each light-detection element may be demodulated with each phase. That means, in known devices, a first modulation signal with the first phase is applied and after that, through the same signal path, a second demodulation signal with the second phase is applied.

However, according to the present disclosure, the modulation signal from the first signal path may be transferred to the second signal path and vice versa, such that the modulation signals, which are already present are used for the respective other light detection element.

For example, in a two-tap operation, charges from the two taps of reversed phases (e.g. zero degrees and hundred-eighty degrees; or ninety degrees and two-hundred-seventy degrees) may be alterna-tively integrated on two charge storage elements, while in order to keep a correct phase information, phases of a light signal is alternated accordingly (i.e. the same light signal is first processed on one signal path and then “chopped” to the second signal path in accordance with the phase readout).

Accordingly, in some embodiments, the time-of-flight demodulation circuitry may be configured to, after the predetermined time period, transfer the first modulation signal from the first signal path to the second signal path and transfer the second modulation signal from the second signal path to the first signal path.

The predetermined time period may be based on the frequency of the modulation signal and may be long enough that a corresponding value (I-value, as generally known in ToF) can be determined.

The present disclosure is not limited to a specific case of how the modulation signals are transferred to the respective signal paths. For example, the transferring may be based on respective switches, which, when a switching signal is applied, switch a connection of the first and second light detection elements to the second and first signal paths, respectively, or may be based on relays, for example. In some embodiments, the transferring is done through or based on chopper circuitry which is provided between the first and the second signal paths.

Chopper circuitry is generally known, such that an extensive discussion thereof is omitted herein. However, it should be noted that the time-of-flight demodulation circuitry may include the chopper circuitry (or any other circuitry suitable to transfer the modulation signals) or may only be configured to control the chopper circuitry (or any other circuitry suitable to transfer the modulation signals).

In some embodiments, the first and second signal paths are provided as input paths for the first and the second light detection elements, whereas in some embodiments, the first and the second signal paths are provided as readout paths for the first and the second light detection elements.

Also, combinations thereof may be envisaged. For example, first time-of-flight demodulation circuitry may be provided for transferring the modulation signals in the respective inputs of the light detection elements and second time-of-flight demodulation circuitry may be provided for transferring the modulation signals in the respective outputs of the light detection elements.

Hence, a switching (as the transferring of the modulation signals is referred to, in some embodiments), may be carried out at a (pixel) input and/or at an output.

In some embodiments, at least one of the first and the second light detection element includes a photodiode, as discussed herein.

In some embodiments, the photodiode is based on (but not limited to) a III-V semiconductor material, as discussed herein.

A III-V semiconductor material may include (but is not limited to) elements of the third and fifth main group of the periodic table. The present disclosure is not limited to any element or any number of different elements which are used in a III-V semiconductor material. For example, the semiconductor material may include or be based on Indium (In), Gallium (Ga), and Arsenic (As). For example, a III-V semiconductor may be based on InGaAs (indium gallium arsenide).

However, as mentioned above, the present disclosure is not limited to any specific III-V semiconductor material. Hence, materials which are used may be based on any phosphide, arsenide, antimonide, or the like, such as GaN (gallium nitride), AlN (aluminum nitride), InN (indium nitride), BN (boron nitride), GaP (gallium phosphide), AlP (aluminum phosphide), InP (indium phosphide), InGaP (indium gallium phosphide), BP (boron phosphide), GaAs (gallium arsenide), AlAs (aluminum arsenide), InAs (indium arsenide), Bas (boron arsenide), GaSb (gallium antimonide), AlSb (aluminum antimoide), InSb (indium antimonide), or the like.

In some embodiments, the III-V semiconductor material includes InGaAs, as discussed herein.

As discussed above, the present disclosure is not limited to any specific semiconductor material, such as III-V materials, as the light detection elements may be based on SiGe (Silicon Germanide), Si (Silicon), or the like, which may be provided as a wafer, as it is generally known.

The light detection element (e.g. photodiode) and integrator (e.g. readout circuitry, as discussed herein) may be provided on a same wafer or on different wafers. In the case of the same wafer, they may be provided on the same semiconductor layer or on a different layer.

Moreover, between the light detection element and the integrator, a buffer circuit, or other circuits may be envisaged.

Generally, the present disclosure is not limited to a photodiode, as discussed herein. Other light detection elements may include a pinned photodiode, a photo gate, a partially-pinned photodiode, or the like.

Moreover, the present disclosure is not limited to two taps (or readout nodes) and the principles of the present disclosure may be generalized to multiple taps like DEM (dynamic element matching techniques).

Some embodiments pertain to a time-of-flight demodulation portion including: a substrate; a first and a second light detection element; an amplifier; and time-of-flight demodulation circuitry, configured to: apply, for a predetermined time period, a first modulation signal to a first signal path including the first light detection element; apply, for the predetermined time period, a second modulation signal to a second signal path including the second light detection element; and after the predetermined time period, transfer the first modulation signal from the first signal path to the second signal path and transfer the second modulation signal from the second signal path to the first signal path, as discussed herein.

The substrate may be based on any semiconductor material as discussed herein, such as a III-V material, SiGe, Si, Ge or the like, as discussed herein.

Hence, in some embodiments, the substrate is based on a III-V semiconductor material, as discussed herein. In some embodiments, the III-V semiconductor material includes InGaAs, as discussed herein. In some embodiments, at least one of the first and the second light detection element includes a photodiode, as discussed herein. In some embodiments, the substrate includes the first and the second light detection elements, as discussed herein.

The amplifier may be any amplifier suitable to amplify a modulation signal according to the present disclosure, such as an impedance amplifier (e.g. capacitive transimpedance amplifier), or the like. Moreover, the amplifier may include a pseudo-differential amplifier, a fully differential amplifier, or the like.

The amplifier may be provided in the same substrate or, if the ToF demodulation portion includes a further substrate (to which it may be referred to as a second substrate, which may e.g. be stacked on the other (first) substrate), the further substrate may include the amplifier.

The second substrate may be based on the same material or a different material than the first substrate.

In embodiments, where the substrate is based on a III-V semiconductor material, an input capacitor may be envisaged for providing isolation of a detector bias and of an amplifier stage.

Moreover, a clamp stage with a predetermined timing may be implemented to prevent noise at a high conversion gain (e.g. kTC noise of an integration capacitor).

Some embodiments pertain to a time-of-flight demodulation method, including: applying, for a predetermined time period, a first modulation signal to a first signal path including a first light detection element; applying, for the predetermined time period, a second modulation signal to a second signal path including a second light detection element; and after the predetermined time period, transferring the first modulation signal from the first signal path to the second signal path and transferring the second modulation signal from the second signal path to the first signal path, as discussed herein.

The ToF demodulation method may be carried out on ToF demodulation circuitry or by ToF demodulation circuitry and/or on a ToF demodulation portion or by a ToF demodulation portion according to the present disclosure.

In some embodiments, the transferring is based on a chopper circuitry which is provided between the first and the second signal paths, as discussed herein. In some embodiments, the first and second signal paths are provided as input paths for the first and the second light detection elements, as discussed herein. In some embodiments, the first and the second signal paths are provided as readout paths for the first and the second light detection elements, as discussed herein. In some embodiments, at least one of the first and the second light detection element includes a photodiode, as discussed herein. In some embodiments, the photodiode is based on a III-V semiconductor material, as discussed herein. In some embodiments, the III-V semiconductor material includes InGaAs, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is depicted a schematic diagram of a ToF demodulation portion 1 including ToF demodulation circuitry according to the present disclosure.

The ToF demodulation portion 1 has a phase input 2 configured to apply a modulation signal with a phase φ to an input 3, thereby passing chopper circuitry 4 (also referred to as light chopper), and to an output 5, thereby passing chopper circuitry 6 (also referred to as electrical chopper), of a pixel 7, wherein the pixel 7 is implemented as a differential electrical system.

The chopper circuitry 4 is serially connected with the pixel seven and with the chopper circuitry 6. One output of the chopper circuitry 4 is connected with a positive input of the pixel 7 and another output of the chopper circuitry 4 is connected with a negative input of the pixel 7.

A negative output of the pixel 7 is connected to an input of the chopper circuitry 6 and a positive output of the pixel 7 is connected to another input of the chopper circuitry 6.

Moreover, the modulation signal is applied to other inputs of the chopper circuitries 4 and 6, such that the chopper circuitries 4 and 6 are in parallel with respect to the phase input 2.

In the light chopper 4, reference clocks may be alternated, whereas in the electrical chopper 6, a chopping stage is alternated. In other words: alternating input-output connections in an electrical chopping stage (electrical chopper 6) are provided with respect to an optical chopping stage (light chopper 4).

According to the embodiment of FIG. 1, chopping is used to remove offset and/or low frequency noise of the pixel 7. Moreover, tap mismatch in the pixel 7 is reduced. Hence, the pixel 7 may be based on a CAPD, gate based iToF pixel, photo gate based iToF pixel, or the like.

The light chopper 4 can be implemented by embedding it with demodulation switches or on a laser (light source) side.

Generally, it is not necessary to provide two chopper circuitries, but two chopper circuitries may be envisaged in some embodiments, in which low-frequency noise and offset mismatches of the pixel 7 should be further minimized.

With a ToF demodulation portion 1, a tap mismatch (which is generally known in ToF), may be reduced or completely avoided and a wide biasing range may be achieved in some embodiments.

During an integration (exposure) phase of the pixel 7, a chopping operation can be engaged one or multiple times. For example, a chopping may be carried out at a middle of the exposure, such that at the end of the integration, charges from both taps will be integrated on the same readout circuit where signal charges are summed while an offset and/or low-frequency noise are cancelled. For multiple chopping operations, the integration time may be divided equally or may be adapted by the skilled person according to the circumstances.

If a series capacitor is added to the input 3 and an amplifier to a non-inverting node to decouple a pixel bias from an integrator circuit (not shown), a wide pixel-bias range may be increased. Moreover, a dynamic range may be increased and a circuit power supply may be optimized, such that mod-ulator pixel bias voltages may be optimized, as well. In other words: According to such embodiments, a negative bias may be applied to a pixel.

To further reduce noise, an amplifier output and source follower input nodes may be decoupled with a series capacitor, for example, in which reset noise may be kept by turning off a CLP switch after turning off an RST switch.

Such an embodiment of a noise-reducing readout circuitry is depicted in FIG. 2.

FIG. 2 depicts time-of-flight demodulation circuitry 10 including two photodiodes 11 and 12 (without limiting the present disclosure in that regard and generally, only one photodiode or more than two photodiodes may be envisaged) with outputs PX1_out and PX2_out which are coupled to chopper circuitry 13. According to the embodiment of figure to, a wide range bias and reset noise cancellation may be provided.

Moreover, readout circuitry 14 and 14′ are shown, wherein readout circuitries 14 and 14′ are each coupled to respective outputs of the chopper circuitry 13. Hence, the readout circuitry 14 is provided in a first signal path 15 and the readout circuitry 14′ is provided in a second signal path 15′. Moreover, the chopper circuitry 13 may be adapted to switch the output signal of the photodiodes 11 from the first signal path to the second signal path or back and the output signal of the photodiode 12 from the second signal path to the first signal path or back.

If alternating phases are applied to photodiodes GD1 and GD2

The readout circuitry 14 includes several transistors which are, in this embodiment, PMOS transistors. However, the transistors may be implemented as NMOS transistors or both PMOS and NMOS transistors, in some embodiments. The chopper circuitry 13 is coupled to a collector of a transistor A including an overflow gate OFG, wherein the collector is coupled to a node, such that one direction leads to a (first) capacitor B and another direction leads to an adjustable (second) capacitor C. The first capacitor is coupled to a node D, such that a reset transistor RST and a negative input of an operational amplifier (op-amp) E (a positive input of the op-amp E is coupled with a reference voltage Vref) are in parallel, wherein the first capacitor B is connected to a source (or drain, in some embodiments) reset transistor RST. The negative input of the op-amp E is connected to the node D and the output of the op-amp E is connected with the reset transistor RST and the second capacitor C, thereby defining a further node F.

The further node F is connected to a source of a transistor SH, wherein the drain of the transistor SH is connected to ground, via a capacitor G, and to a further capacitor H. The further capacitor H is connected to a node I, wherein one direction of the node I leads to an source of a PMOS transistor CLP and another direction leads to a gate of an NMOS transistor J, wherein the source of the NMOS transistor J is connected to the collector of an NMOS selection transistor SEL0, which is connected to the column shared current source.

The readout circuitry 14′ is replica of the readout circuitry 14 except that the selection transistor may be controlled differently, which is indicated, in the readout circuitry 14′ as the selection transistor is named SEL1. However, SEL1 and SEL0 may also be identical in some embodiments.

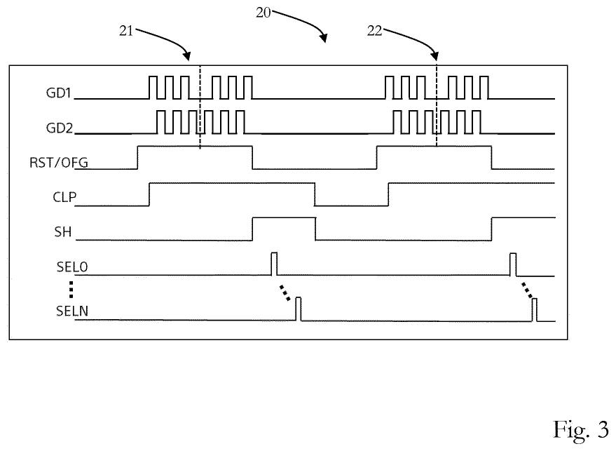

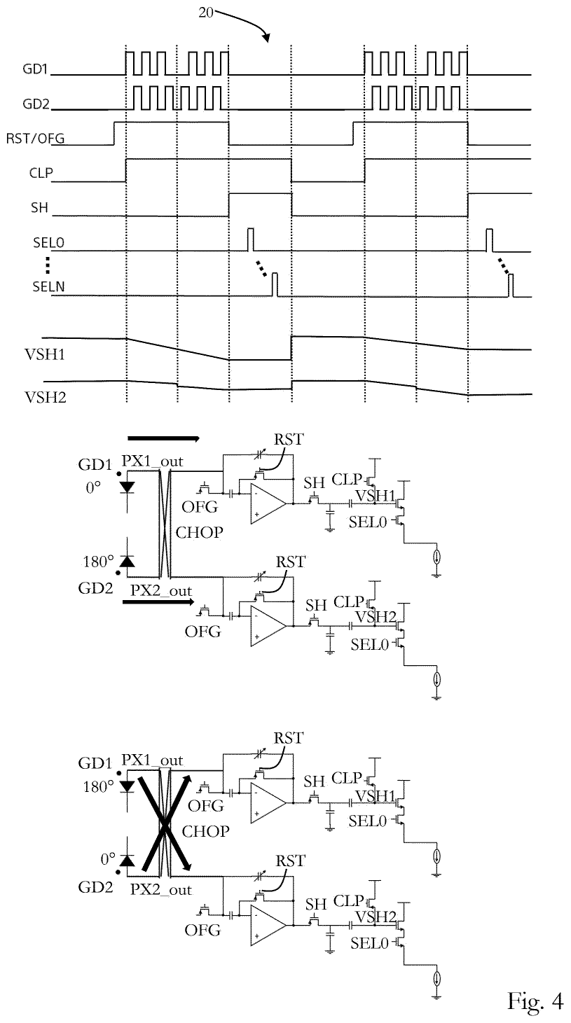

FIG. 3 depicts a timing diagram for signals as they are measured at respective elements of the circuit of FIG. 2.

It should be noted that FIG. 2 depicts only two photodiodes, but the present disclosure is not limited to any number of photodiodes, as can be recognized in FIG. 3 since a selection transistor with the numbering N is shown, thereby symbolically representing an N^{th} pixel.

For the photodiodes 11 and 12 (in FIG. 3 GD1 and GD2), it is indicated with a dashed line at which point the modulation signals are transferred (or switched or chopped or alternated) to the respective other signal line (i.e. when the predetermined time period is over). In this embodiment, one time chopping is shown as an example, however, the present disclosure is not limited to any number of chopping.

In total, four taps (or quads) are measured in two demodulation cycles 21 and 22.

In the (first) demodulation cycle 21, before the switching GD1 is driven with a modulation signal of zero degrees and GD2 is driven with one-hundred-eighty degrees and after the switching, the modulation signals are alternated to the respective other photodiode, i.e. GD1 is driven with a modulation signal of one-hundred eighty degrees and GD2 is driven with zero degrees.

In the (second) demodulation cycle 22, before the switching GD1 is driven with a modulation signal of ninety degrees and GD2 is driven with two-hundred-seventy degrees and after the switching, the modulation signals are alternated to the respective other photodiode, i.e. GD1 is driven with a modulation signal of two-hundred-seventy degrees and GD2 is driven with ninety degrees.

As can be taken from FIG. 3, although chopping operation is implemented, charges from two sepa-rate pixels (i.e. the photodiodes) can be integrated on the same integration capacitor, such that two-tap operation is enabled, while phase information is sampled with tap-mismatch being reduced. Moreover, frame rate can be increased almost twice since, instead of four phases, only two phases are necessary due to the free mismatch.

In FIG. 4, an extended version of the timing diagram 20 is depicted on the top, and the timing diagram 20 is further discussed based on the ToF demodulation circuitry 10, which is depicted in the middle of FIG. 4 (in a state “before chopping”) on the bottom of FIG. 4 (in a state “after chopping”).

Before chopping, a signal pathway of the photodiode GD1 is straight to the readout circuitry 14 and a signal pathway of the photodiode GD2 is straight to the readout circuitry 14′, as indicated with straight arrows in the circuit diagram.

The modulation signal of zero degrees of GD1 is integrated in the readout circuitry 14 and a voltage of VSH1 changes accordingly, as indicated on the bottom of the extended timing diagram 20. The modulation signal of one-hundred-eighty degrees of GD2 is integrated in the readout circuitry 14′ and a voltage of VSH2 changes accordingly, as indicated on the bottom of the extended timing diagram 20.

After chopping, a signal pathway of the photodiode GD1 is into the direction of the readout circuitry 14′ and a signal pathway of the photodiode GD2 is into the direction of the readout circuitry 14, as indicated with crossed arrows.

Then, the modulation signal of zero degrees of GD2 is integrated in the readout circuitry 14 and a voltage of VSH1 changes accordingly, as indicated on the bottom of the extended timing diagram 20.

The modulation signal of one-hundred eighty degrees of GD1 is integrated in the readout circuitry 14′ and a voltage of VSH 2 changes accordingly, as indicated on the bottom of the extended timing diagram 20.

The case for ninety and two-hundred-seventy degrees is similar, such that a repetitive description thereof is omitted.

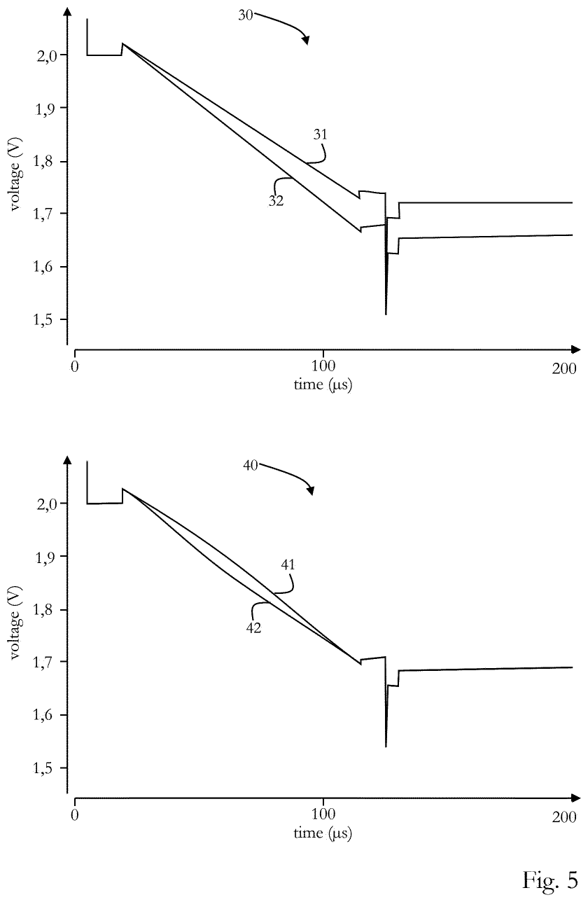

FIG. 5 depicts a comparison of a voltage progression (voltage versus time) at the VSH nodes (VSH1 and VSH2) of ToF demodulation circuitry without chopping (top) and of ToF demodulation circuitry according to the present disclosure (bottom) (i.e. with chopping).

Hence, on the top of FIG. 5, a voltage progression 30 (without chopping) is shown, an on the bottom of FIG. 5, a voltage progression 40 (with) chopping is shown, wherein the present disclosure is not limited to a specific chopping frequency. Moreover, the chopping frequency may be adapted accordingly depending on the circumstances.

The two voltage progressions 30 and 40 are results of a simulation in which gain mismatch cancellation was analyzed.

A light detection element or photodiode is assumed to be the main source of mismatch. Different gains are set for two current source blocks to model the detector gain mismatch. CTIA and SF (Source Follower) are assumed to be identical. As generally known in ToF, I-values (I1 to I4), which are indicative of the depth are determined. In this case, the following formulas are assumed:

I1+I2=Gain1*IDET

I3+I4=Gain2*IDET,

wherein IDET represent a detector current, i.e. a current which results from a photon conversion. Exposure durations of both PFEs (Pixel front-end circuit, which is an embodiment of readout circuitry according to the present disclosure) are kept the same. At the output, it is expected to observe similar voltages (or the same voltage in an ideal case), if there is no tap mismatch.

As indicated above, the voltage is measured at the VSH (sample and hold voltage) nodes.

Accordingly, the two lines of the voltage progressions represent the two VSH nodes. In particular, curves 31 (for graph 30) and 41 (for graph 40) are the voltages at node VSH1 and curves 32 (for graph 30) and 42 (for graph 40) are the voltages at node VSH2.

According to the simulation results, at the end of the integration, there is sixty-four milivolts of voltage difference in for the voltage progression 30 and no ninety-four microvolts tap mismatch for the voltage progression 40

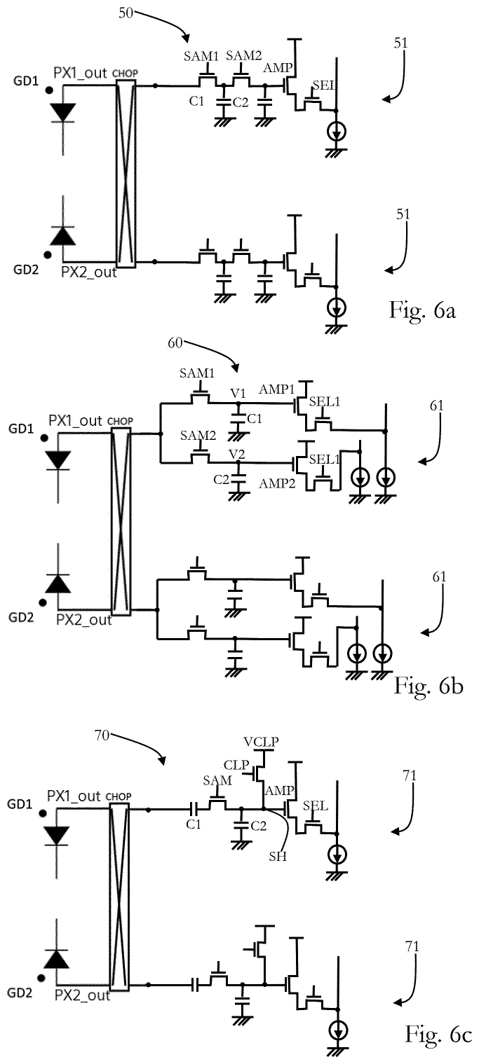

FIG. 6 is divided in FIG. 6a to FIG. 6c each depicting circuit diagrams of further embodiments 50, 60, and 70 of ToF demodulation circuitry according to the present disclosure.

The diagrams have a same first part, i.e. a photodiode pair in a first and a second signal path with chopper circuitry as has been discussed under reference of FIG. 2.

However, the respective readout circuitries are different.

In FIG. 6a, ToF demodulation circuitry 50 is shown including ToF readout circuitry 51 at each output of the chopper, i.e. the same readout circuitry is provided for each output of the chopper (which also holds for ToF demodulation circuitry 60 in FIGS. 6b and 70 in FIG. 6c).

ToF readout circuitry 51 depicts a serial arrangement of transistors (which are MOSFETs, if not stated otherwise, in these embodiments, wherein the present disclosure is not limited to any specific type of transistors) and capacitors.

A transistor SAM1 is connected to the output of the chopper. A transistor S1 is connected to a capacitor C1 (which is then connected to ground) and to a further transistor SAM2. A transistor SAM2 is connected to a further capacitor and to a gate of an amplifier transistor AMP. The amplifier transistor is an NMOS transistor and its source is connected to a selection transistor (being an NMOS transistor), which is connected to a column shared current source

ToF readout circuitry 61 in FIG. 6b is based on a parallel arrangement of transistors and capacitors.

Each output of the chopper is coupled to a node which divides the ToF readout circuitry into two parallel, identical paths. Each path is coupled, via aa transistor SAM1 (or SAM2) to the output of the chopper. The transistor SAM1 or SAM2 is coupled, via a node V1 (or V2) to a capacitor C1 (or C2), which is coupled to a gate of a transistor AMP1 (or AMP2), which is an n-p-n transistor whose emitter is coupled to an emitter of a p-n-p selection transistor SEL1, which is coupled to ground.

ToF readout circuitry 71 in FIG. 6c represents an analog CDS (correlated double sampling).

Each output of the chopper is coupled to a capacitor C1, which is coupled to an emitter of a transistor SAM. A collector of the transistor SAM is coupled to a capacitor C2 which is grounded and to a node SH, wherein the node SH divides the path. One direction of the node SH is a connection of a emitter of a transistor CLP, which is coupled to a voltage source VCLP with its collector. Another direction of the node SH is coupled to a gate of a transistor AMP, which is connected, with an emitter, to an emitter of a selection transistor SEL, whose collector is grounded.

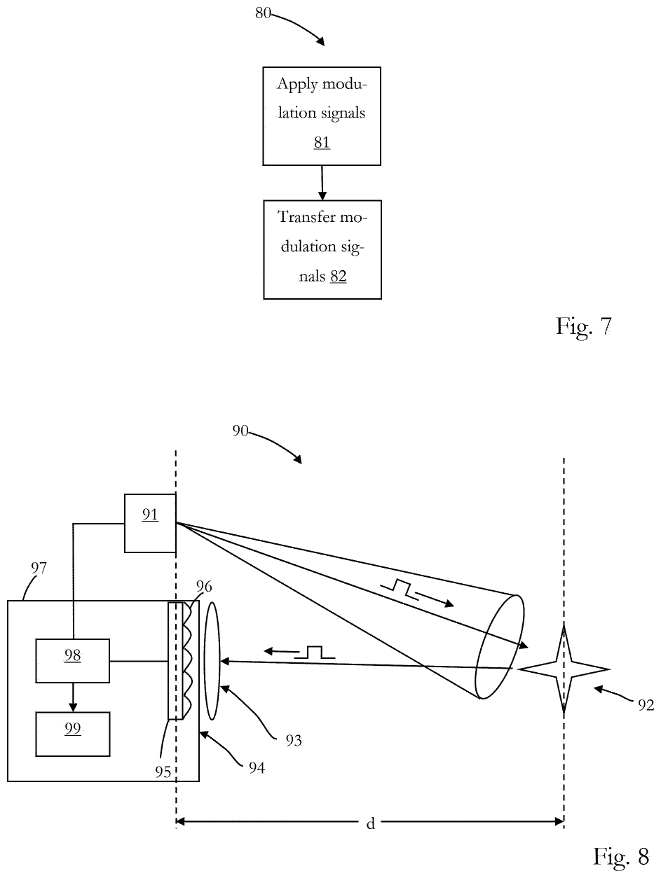

FIG. 7 depicts an embodiment of a ToF demodulation method 80 according to the present disclosure.

At 81, a first modulation signal is applied for a predetermined time period to a first signal path including a first light detection element, as discussed herein a second modulation signal is applied for the predetermined time period to a second signal path including a second light detection element, as discussed herein.

At 82, after the predetermined time period, the first modulation signal is transferred from the first signal path to the second signal path and the second modulation signal is transferred from the second signal path to the first signal path, as discussed herein.

Referring to FIG. 8, there is illustrated an embodiment of a time-of-flight (ToF) imaging apparatus 90, which can be used for depth sensing or providing a distance measurement, in combination with the technology as discussed herein, wherein the ToF imaging apparatus 90 is configured as an iToF camera. The ToF imaging apparatus 90 has ToF demodulation circuitry 97, which is configured to carry out an iToF depth measurement and which forms a control of the ToF imaging apparatus 90 (and it includes, not shown, corresponding processors, memory and storage, as it is generally known to the skilled person).

The ToF imaging apparatus 90 has a modulated light source 91 and it includes light emitting elements (based on laser diodes), wherein in the present embodiment, the light emitting elements are narrow band laser elements.

The light source 91 emits light, i.e. modulated light, as discussed herein, to a scene 92 (region of in-terest or object), which reflects the light. The reflected light is focused by an optical stack 93 to a light detector 94.

The light detector 94 is implemented based on multiple photodiodes, as discussed herein, and based on a micro lens array 96 which focuses the light reflected from the scene 91 to an imaging portion 95 (to each pixel of the image ToF demodulation circuitry 97).

The light emission time and modulation information is fed to ToF demodulation circuitry or control 97 including a time-of-flight measurement unit 98, which also receives respective information from the imaging portion 95, when the light is detected which is reflected from the scene 92. On the basis of the modulated light received from the light source 91, the time-of-flight measurement unit 98 computes a phase shift of the received modulated light which has been emitted from the light source 91 and reflected by the scene 92 and on the basis thereon it computes a distance d (depth infor-mation) between the imaging portion 95 and the scene 92.

The depth information is fed from the time-of-flight measurement unit 98 to a 3D image recon-struction unit 99 of the ToF demodulation circuitry 97, which reconstructs (generates) a 3D image of the scene 92.

FIG. 9 depicts an embodiment of ToF readout circuitry 100 implemented as a clamp stage, as discussed above, according to the present disclosure for controlling a readout timing.

In parallel, an input with a pixel bias voltage PXBIAS and an input with a detector voltage VDETCOM are shown on the left side of FIG. 9. VDETCOM supplied a capacitor and a diode, which are in parallel. A node 101 connects the signal lines having PXBIAS and VDETCOM with each other. However, between the node 101 and the input of PXBIAS, a reset switch RST is provided.

Moreover, right of the node 101 a capacitor C_int is provided, which is in parallel with a capacitor C_in. Moreover, a node 102 splits an input of C_in, such that a positive input of an op-amp 103 is connected with C_in in parallel, a further reset switch RST is provided. The negative input of the op-amp 103 is supplied with an amplifier bias voltage AMPBIAS. An output of the op-amp 103, outputting a voltage VINT is coupled with the further reset switch RST and C_int via a node 104. A further switch SH is connected with the node 104, such that, if the switch SH is closed, a capacitor C_I and a capacitor C_SH, which is in parallel to the capacitor C_I are connected with the node 104.

The capacitor C_SH is, at its other end connected to a node 105. The node 105 further connects a clamp switch CLP, to which a supply voltage CLPBIAS is applied, with a gate of a transistor 106, such that in total, the transistor 106 is supplied with a voltage VSH. At one other end, the transistor VSH is supplied with a voltage VDDLM and with a second other end, the transistor 106 is con-nected with a selection switch, which can be switched for applying a voltage VSL at an output.

C_in capacitor in FIG. 9 is used to decouple an inverting input of the op-amp 103 and the node 101. When the reset switch RST is in an ON-state, the node 101 is biased by the pixel bias voltage PXBIAS (which is an external bias) and the inverting input of the op-amp 103 is settled to the am-plifier bias voltage AMPBIAS level. A minimum and maximum detector bias voltage levels that can be supported are determined by ON and OFF resistances of the reset switch RST (assuming C_in and 100 do not limit the operation).

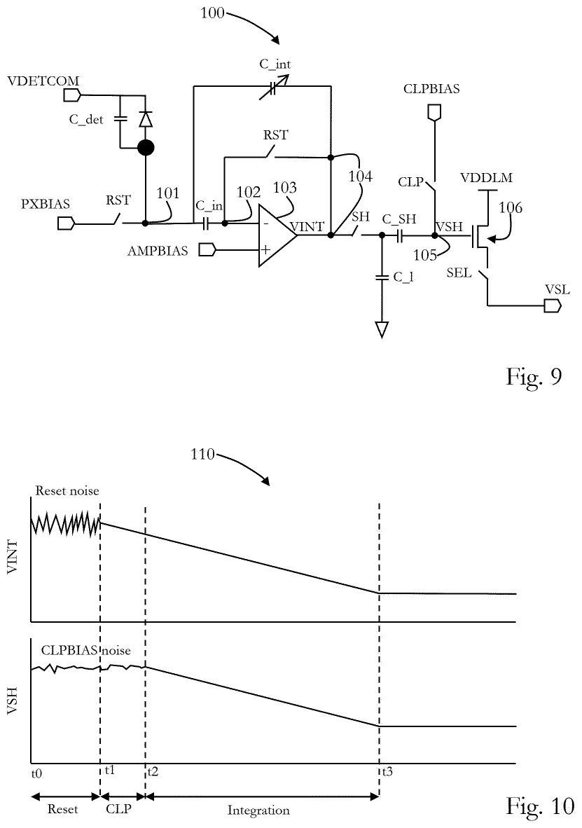

FIG. 10 depicts a timing diagram 10 of the nodes VINT and VSH of the clamp stage of FIG. 9.

During a reset phase, which lasts from time points t0 to t1, reset noise is present at VINT and clamp stage bias noise is present at VSH. During a clamp phase CLP, which lasts from t1 to t2, the voltage VINT starts decreasing while at VSH CLPBIAS noise is still present.

During an integration phase, which lasts from t2 to t3, VINT still decreases roughly linearly as during the clamp phase, whereas VSH starts decreasing linearly. Both voltages VINT and VSH become constant after t3 (until a next reset phase).

The respective voltages can be modelled according to the formulas of the following table, wherein the formular are read as Node(Time Point) equals Term:

| Time point | Node | Term |
|---|---|---|
| t1 | VINT | AMPBIAS + V_offset-amp + v_r, reset |
| t2 | VINT | VINT(t1) + I_DET*(t2-t1)/C_DET |
| t3 | VINT | VINT(t1) + (I_DET*(t3-t1)/C_DET) |
| t1 | VSH | CLPBIAS + v_n, clp |
| t2 | VSH | CLPBIAS + v_n, clp |
| t3 | VSH | CLPBIAS + v_n, clp + I_DET*(t3-t2)/C_DET |

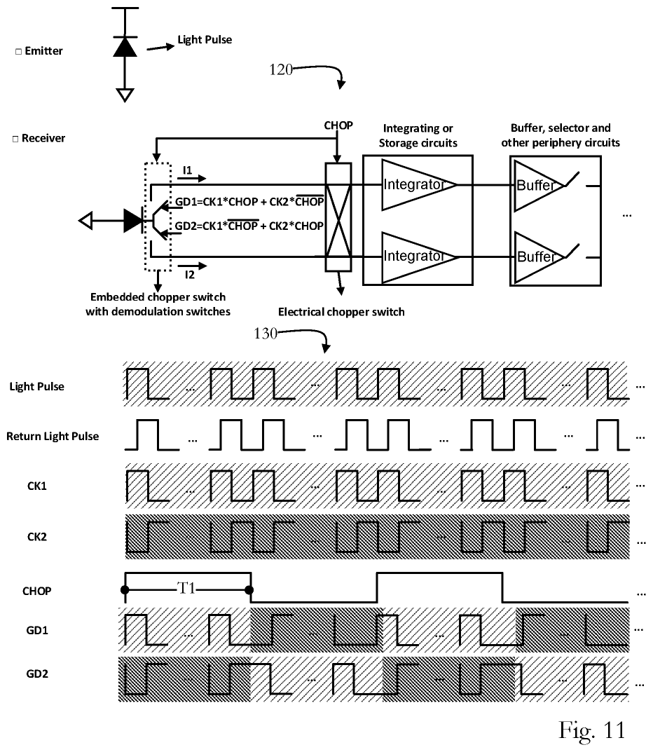

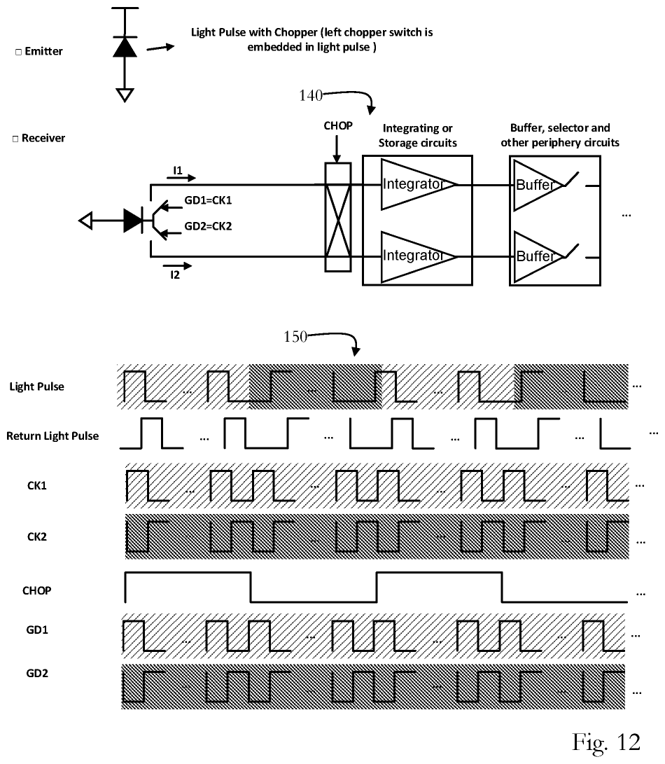

FIG. 11 depicts ToF readout circuitry 120 according to the present disclosure and timing diagrams 130 according to which the ToF readout circuitry is controlled. The ToF readout circuitry is syn-chronized with a modulated light pulse, emitted by an emitter, to which a chopping according to the present disclosure is applied. Hence, a returning light pulse is detected and/or read by a receiver (i.e. the ToF readout circuitry 120).

The receiver includes two clocks CK1 and CK2. A signal applied to CK 1 corresponds to a modula-tion signal of the emitter. A signal applied to CK2 corresponds to the inverted signal of CK 1.

Moreover, a chopping circuitry CHOP is included in the ToF readout circuitry 120, which is configured to transfer signals from signal lines GD1 and GD2 to the respective other signal line, as discussed herein. If a signal is applied to the chopping circuitry CHOP, clock signal CK1 is applied to GD1 and CK2 is applied to GD2. Hence, the CHOP signal is applied for a predetermined amount of time T1. After that, also for the time amount T1, the SIGNAL chop is set to (logic) zero, such that CK2 is applied to GD1 and CK1 is applied to GD2. This progression can is performed for a predetermined amount of time, i.e. until the ToF measurement is over.

The signal read from GD1 can then be calculated as:

GD1=CK1*CHOP+CK2*(1-CHOP)

GD2=CK1*(1-CHOP)+CK2*CHOP

After the signal from GD1 and GD2 passes the chopper circuitry, it is transmitted to integration or storage circuitry and buffer, selector and other periphery circuits, as it is generally known.

Hence, according to the embodiment of FIG. 11, a light chopping switch (as discussed under refer-ence of FIG. 1) can be provided, in which, instead of applying phase-consistent clocks for GD1 (e.g. zero or one-hundred eighty degrees) and GD2 (e.g. ninety or two-hundred seventy degrees), the phases of GD1 and GD2 depend on a CHOP clock. If the CHOP clock toggles, GD1 or GD2 switch their phase to ensure a correct time resolution of phase information between the demodula-tion clocks CK1 and CK2, i.e. for GD1 and GD2 and the returned light pulse.

FIG. 12 depicts ToF readout circuitry 140 which basically corresponds to the ToF readout circuitry 120, such that a repetitive description thereof is omitted. However, the signals which are applied to the respective elements are different as can be taken from timing diagram 150.

The timing diagram 150 is different from the timing diagram 130 in that the light pulse signal is al-ready chopped, such that when the chopping signal CHOP is applied to the ToF readout circuitry 140, the signal CK1 corresponds to GD1 and CK2 corresponds to GD2. Hence, in this embodi-ment, a light chopping is carried out, whereas in the embodiment of FIG. 11, an electric chopping is carried out.

Hence, according to embodiment of FIG. 12, instead of applying a phase-consistent light pulse, a phase of the light pulse depends on a CHOP clock. If the CHOP clock toggles, the light pulse switches its phase to ensure a correct time resolution of phase information between phase consistent demodulation clocks, i.e. GD1 or GD2 and the CHOP controlled returned light pulse.

However, the present disclosure is not limited to the case that a light chopping or an electric chopping may be carried out since both may be carried out, as well.

Although FIGS. 11 and 12 depict, for example one photodiode, more photodiodes may be envisaged, in some embodiments. Moreover, the present disclosure is not limited to two taps since three or more taps may be envisaged for chopping since the CHOP signal can be divided accordingly, such that dynamic element matching (DEM) may be carried out. Furthermore, the present disclosure is not limited to a specific passive or active integrator/storage circuits.

The present disclosure is also not limited to a specific readout circuitry structure, i.e. buffer, selector and/or any other periphery circuit. Moreover, every readout circuitry may be used completely inde-pendent of a chopping discussed herein.

Accordingly, some embodiments pertain to time-of-flight readout circuitry with low noise and wide biasing range for an SWIR sensor or any other sensor, including: a clamp stage (such as the clamp stage discussed under reference of FIG. 9); and circuitry configured to: proportionally decrease an first voltage starting from a reset noise at a first point of time; proportionally decrease a second volt-age starting from a clamp bias noise at a second point of time after the first point of time; and stop decreasing the first and the second voltages at a third point of time after the second point of time.

In some embodiments, the first voltage is an integrator voltage.

In some embodiments, the first voltage is detectable at an amplifier output.

In some embodiments, the second voltage is detectable at the clamp (bias) stage.

Please note that the division of the control 97 into units 98 and 99 is only made for illustration pur-poses and that the present disclosure is not limited to any specific division of functions in specific units. For instance, the control 99 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a com-puter program is provided are envisaged as aspects of the present disclosure.

Note that the present technology can also be configured as described below.

(1) Time-of-flight demodulation circuitry, configured to:
apply, for a predetermined time period, a first modulation signal to a first signal path including a first light detection element;
apply, for the predetermined time period, a second modulation signal to a second signal path including a second light detection element; and
after the predetermined time period, transfer the first modulation signal from the first signal path to the second signal path and transfer the second modulation signal from the second signal path to the first signal path.

(2) The time-of-flight demodulation circuitry of (1), wherein the transferring is based on chop-per circuitry which is provided between the first and the second signal paths.

(3) The time-of-flight demodulation circuitry of (1) or (2), wherein the first and second signal paths are provided as input paths for the first and the second light detection elements.

(4) The time-of-flight demodulation circuitry of anyone of (1) to (3), wherein the first and the second signal paths are provided as readout paths for the first and the second light detection elements.

(5) The time-of-flight demodulation circuitry of anyone of (1) to (4), wherein at least one of the first and the second light detection element includes a photodiode.

(6) The time-of-flight demodulation circuitry of (5), wherein the photodiode is based on a III-V semiconductor material.

(7) The time-of-flight demodulation circuitry of (6), wherein the III-V semiconductor material includes InGaAs.

(8) A time-of-flight demodulation portion comprising:
a substrate;
a first and a second light detection element;
an amplifier; and
time-of-flight demodulation circuitry, configured to:
apply, for a predetermined time period, a first modulation signal to a first signal path including the first light detection element;
apply, for the predetermined time period, a second modulation signal to a second signal path including the second light detection element; and
after the predetermined time period, transfer the first modulation signal from the first signal path to the second signal path and transfer the second modulation signal from the second signal path to the first signal path.

(9) The time-of-flight demodulation portion of (8), wherein the substrate is based on a III-V semiconductor material.

(10) The time-of-flight demodulation portion of (9), wherein the III-V semiconductor material includes InGaAs.

(11) The time-of-flight demodulation portion of anyone of (8) to (10), wherein at least one of the first and the second light detection element includes a photodiode.

(12) The time-of-flight demodulation portion of (11), wherein the substrate includes the first and the second light detection elements.

(13) The time-of-flight demodulation portion of (12), further including a further substrate including the amplifier.

(14) A time-of-flight demodulation method, comprising
applying, for a predetermined time period, a first modulation signal to a first signal path including a first light detection element;
applying, for the predetermined time period, a second modulation signal to a second signal path including a second light detection element; and
after the predetermined time period, transferring the first modulation signal from the first signal path to the second signal path and transferring the second modulation signal from the second signal path to the first signal path.

(15) The time-of-flight demodulation method of (14), wherein the transferring is based on a chopper circuitry which is provided between the first and the second signal paths.

(16) The time-of-flight demodulation method of (14) or (15), wherein the first and second signal paths are provided as input paths for the first and the second light detection elements.

(17) The time-of-flight demodulation method of anyone of (14) to (16), wherein the first and the second signal paths are provided as readout paths for the first and the second light detection elements.

(18) The time-of-flight demodulation method of anyone of (14) to (17), wherein at least one of the first and the second light detection element includes a photodiode.

(19) The time-of-flight demodulation method of (18), wherein the photodiode is based on a III-V semiconductor material.

(20) The time-of-flight demodulation method of (19), wherein the III-V semiconductor material includes InGaAs.

(21) A computer program comprising program code causing a computer to perform the method according to anyone of (14) to (20), when being carried out on a computer.

(22) A non-transitory computer-readable recording medium that stores therein a computer program product, which, when executed by a processor, causes the method according to anyone of (14) to (20) to be performed.

(23) Time-of-flight readout circuitry including:
a clamp stage, and
circuitry configured to:
proportionally decrease an first voltage starting from a reset noise at a first point of time;
proportionally decrease a second voltage starting from a clamp bias noise at a second point of time after the first point of time; and
stop decreasing the first and the second voltages at a third point of time after the second point of time.

(24) The time-of-flight readout circuitry of (23), wherein the first voltage is an integrator voltage.

(25) The time-of-flight readout circuitry of (23) or (24), wherein the first voltage is detectable at an amplifier output.

(26) The time-of-flight readout circuitry of anyone of (23) to (25), wherein the second voltage is detectable at the clamp stage.

1. Time-of-flight demodulation circuitry, configured to:
apply, for a predetermined time period, a first modulation signal to a first signal path including a first light detection element;
apply, for the predetermined time period, a second modulation signal to a second signal path including a second light detection element; and
after the predetermined time period, transfer the first modulation signal from the first signal path to the second signal path and transfer the second modulation signal from the second signal path to the first signal path.

2. The time-of-flight demodulation circuitry of claim 1, wherein the transferring is based on chopper circuitry which is provided between the first and the second signal paths.

3. The time-of-flight demodulation circuitry of claim 1, wherein the first and second signal paths are provided as input paths for the first and the second light detection elements.

4. The time-of-flight demodulation circuitry of claim 1, wherein the first and the second signal paths are provided as readout paths for the first and the second light detection elements.

5. The time-of-flight demodulation circuitry of claim 1, wherein at least one of the first and the second light detection element includes a photodiode.

6. The time-of-flight demodulation circuitry of claim 5, wherein the photodiode is based on a III-V semiconductor material.

7. The time-of-flight demodulation circuitry of claim 6, wherein the III-V semiconductor material includes InGaAs.

8. A time-of-flight demodulation portion comprising:
a substrate;
a first and a second light detection element;
an amplifier; and
time-of-flight demodulation circuitry, configured to:
apply, for a predetermined time period, a first modulation signal to a first signal path including the first light detection element;
apply, for the predetermined time period, a second modulation signal to a second signal path including the second light detection element; and
after the predetermined time period, transfer the first modulation signal from the first signal path to the second signal path and transfer the second modulation signal from the second signal path to the first signal path.

9. The time-of-flight demodulation portion of claim 8, wherein the substrate is based on a III-V semiconductor material.

10. The time-of-flight demodulation portion of claim 9, wherein the III-V semiconductor material includes InGaAs.

11. The time-of-flight demodulation portion of claim 8, wherein at least one of the first and the second light detection element includes a photodiode.

12. The time-of-flight demodulation portion of claim 11, wherein the substrate includes the first and the second light detection elements.

13. The time-of-flight demodulation portion of claim 12, further including a further substrate including the amplifier.

14. A time-of-flight demodulation method, comprising applying, for a predetermined time period, a first modulation signal to a first signal path including a first light detection element;
applying, for the predetermined time period, a second modulation signal to a second signal path including a second light detection element; and
after the predetermined time period, transferring the first modulation signal from the first signal path to the second signal path and transferring the second modulation signal from the second signal path to the first signal path.

15. The time-of-flight demodulation method of claim 14, wherein the transferring is based on a chopper circuitry which is provided between the first and the second signal paths.

16. The time-of-flight demodulation method of claim 14, wherein the first and second signal paths are provided as input paths for the first and the second light detection elements.

17. The time-of-flight demodulation method of claim 14, wherein the first and the second signal paths are provided as readout paths for the first and the second light detection elements.

18. The time-of-flight demodulation method of claim 14, wherein at least one of the first and the second light detection element includes a photodiode.

19. The time-of-flight demodulation method of claim 18, wherein the photodiode is based on a III-V semiconductor material.

20. The time-of-flight demodulation circuitry of claim 19, wherein the III-V semiconductor material includes InGaAs.
